(19) United States
(12) Patent Application Publication
(10) Pub. No.: US 2013/0185384 A1
(43) Pub. Date: Jul. 18, 2013

(54) Unified Virtual Cloud

(71) Applicant: Raghavan Menon, (US)

(72) Inventor: Raghavan Menon, (US)

(21) Appl. No.: 13/610,889

(22) Filed: Sep. 12, 2012

Related U.S. Application Data
(60) Provisional application No. 61/533,742, filed on Sep. 12, 2011.

(51) Int. Cl. H04L 29/06

(52) U.S. Cl. CPC H04L 29/06823
USPC 709/217

(57) ABSTRACT

Method and apparatus to unify all of a persons' data from all his devices and services including without limitation computers, smartphones, online cloud storage services, and offline pluggable hard drives and also including all data that has been shared with said person by others into a virtual cloud for that person which can be accessed, searched, browsed, managed, replicated, backed up from anywhere and any portion of which can be shared with others with fine grain access control lists that control what all the sharee can do. This method and apparatus also including mechanisms to deal with portions of the cloud that may be offline or behind slow links with smart caching and mechanisms to access data on this virtual cloud using the fastest, cheapest, or most reliable means. This virtual cloud also including all services that the person has access to.

### BACKGROUND

A person today generates an enormous amount of data in his personal life. Examples are
1. Video from HD camcorders. Many would like to archive their unedited videos with minimal compression. This is 8 GB per hour in 1080 p even with the 2 best rate (17 Mbits/sec). One hour of video per week on average results in over 400 GBytes of video per year. This data is only going to increase with 3D.
2. Photos from digital cameras with increasing resolution. Again many would like to archive their unedited and maybe uncompressed photos in RAW formats. 16 Mbytes per image (10 mega pixel RAW) and say 100 images per month results in 20 GBytes per year.
3. Scanned versions of personal documents
4. Photos and videos from smart phones
5. Early plans to allow people to “record their life” with unobtrusive video and audio capturing every moment of a person's life and providing a searchable memory that never fades. This will generate terabytes of very sensitive data per person per year.

People also have sets of critical irreplaceable documents that they like to have scanned versions kept in secure encrypted storage to be accessed from anywhere.

Businesses and other organizations have teams that need large amounts of storage with fine grained sharing controls.

Today, large amounts of very sensitive data like this are kept inside the person's home or personal computers.

This invention provides access to ALL our data (including data that has been shared with us), from anywhere, and sharing of any portion of our data to anyone with high security and fine grained access control.

Today, it is difficult to access this data remotely or share pieces of the data with fine grained access control. The following are the current methods:
1. Software like Logmein or pcanywhere which allows remote control of PC's and access to all data on it. This is very slow and inconvenient.
2. VPN software that puts the PC's where the data resides on a virtual network. Again, slow and difficult to provide sharing.
3. Upload data to a cloud service like dropbox (or use services like ge.tt or letscrate.com. All these put the data on the cloud. It is not cost effective to put hundreds of GB on the cloud.
4. Share the data with peer to peer sharing software like sendoid or bittorrent. This allows hundreds of GB to be shared but access control and security are minimal.
5. Use online services like google web albums or vimeo which do provide reasonably fine grained sharing but (a) these only store specific media and (b) not cost effective to store hundreds of GB.

With large amounts of data (hundreds of GB), the user also usually needs a place where they can have the data on a local LAN for fast browsing and processing. So the requirement is, all of the above for universal access, fine grained sharing, access control etc . . . with fast access for editing.

Our second goal with this invention is to extend this controlled, finely sharable, universal access to all services (with data just being a service provide by a storage provider; the storage provider could be just a hard drive attached to a PC at home).

This invention (called HyperCloud) provides a new paradigm for managing providers of services (including providers of storage) that allows for access from anywhere, sharing with fine grained control, security, provides a framework for value added services like backups, data caching for improved performance, global searches, and allows extreme ease of use with one click creation of access tokens and URL's that provide controlled access to the service or data (data is simply a service provide that provides storage) to individuals or groups.

This invention, HyperCloud, creates a “virtual cloud” per entity which contains everything that an entity has access to. This “virtual cloud” is a single point of access by its owning entity for everything in this cloud. The entity can share any portion of this cloud (a portion being called a cloudlet) with any other entity (receiving entity) with fine grained access control that indicates what the receiving entity can do with it: for e.g., read only access, read/write access, ability to re-share it with different access control, service specific controls etc . . . ). Through HyperCloud, each entity, in its virtual cloud sees all its own devices/data/services as well as everything that has been shared with it.

### How Do Devices/Data/Services Become Part of a Virtual Cloud?

Each computing device registers itself with HyperCloud providing credentials that allow it to join an existing virtual cloud or become a single device virtual cloud. The device can also publish a list what it is making visible to the virtual cloud. The list itself may be searchable or hidden (you must know it exists to find it) or some combination of that.

A computing device (henceforth just called “Device”) can become part of multiple virtual clouds which may see common or different portions of data or services on that Device.

Something as small as one portion of one file on a Device can be registered. Once registered, that can be accessed by anyone with the correct token. The registration and token generation step can also happen in one operation which results in a sharable token that provides access to that portion of that file for a limited time (if specified).

A Device that wishes to provide continuous access to itself through the cloud will run a server on it that allows the cloud to contact it (and wake it up if needed from power save) to access the services it is exporting to the cloud. A Device that wishes to provide temporary access can run a temporary server which could also run inside a browser.

### What Can a Device Export to be Part of a Virtual Cloud?

Files, folders, and entire drives can be exported making all of this accessible through the virtual cloud.

Any service that the Device wants to make accessable can be exported. Example: a printer on the Device can be exported to the virtual cloud. This allows the virtual cloud owner to access that printer from anywhere and also allows him to generate tokens to allow others print to that printer through HyperCloud. Similarly, any service can be made part of the virtual cloud including special services which the cloud itself may not understand (called a “Raw Service”). For a Raw Service, the cloud shows the name and description that the providing Device gave, indicates what kinds of data the Raw Service can provide/accept (which could also be just raw binary data), and allows users to access this service with minimal interpretation. For services that HyperCloud understands it provides added services. For e.g. for a printer the cloud can provide spooling and protocol translation (from PDF to PCL for e.g.).

### Why Would a Device Provide a Service Through Hypercloud? Why Not Just Directly Make the Service Accessible Over the Internet Through an Open Port or a Local Web Server?

HyperCloud wraps all services that go through it with a layer providing security, authentication of users, fine grained access control, easy controlled sharing (e.g. a URL based token allowing a user to print 50 pages within next hour at that URL; a user creates this to allow his friend who has come to his house to print a document to his printer at home).

HyperCloud proposes to have a generic and universal layer that provides all these aspects to all services on the internet that go through it. Without this invention, every service on the internet must implement all these functions.

### Are the Users of this Virtual Cloud Service Just People?

No. We anticipate that Devices that need to access services on other Devices will soon choose to do it through HyperCloud. This is because HyperCloud provides the security, authentication, service discovery, and access control layer that is essential for effective wide spread inter Device communication. HyperCloud is the framework that swarms of smart embedded computers will use to find and get access to each other.

### Is HyperCloud a Relay for All Data?

No. Actual data transfer is intended to be p2p. The servers on two Devices will try and talk to each other directly over the internet once HyperCloud connects them. However, where p2p is not possible due to firewalls or NAT, HyperCloud will act as a relay for data.

### Is HyperCloud Just a Directory Service?

No. A directory service simply allows discovery. HyperCloud can provide a Directory Service to allow discovery of public services or for-pay services. HyperCloud also provides secure access and sharing for all data along with mechanisms to identify the best way (fastest or cheapest or most reliable way) to get to the data.

1. An Internet server which registers services provided by computing devices in the local network or worldwide whether directly on the internet or behind firewalls into groups called “Virtual Cloud”s.

2-23. (canceled)
